(19) United States
(12) Patent Application Publication
(10) Pub. No.: US 2013/0209852 A1
(43) Pub. Date: Aug. 15, 2013

(54) ELECTROCHEMICAL ENERGY STORE

(71) Applicants: Erhard Schletterer, Dresden (DE); Tim Schaefer, Harztor (DE); Claus-Rupert Hohenthanner, Hanau (DE); Joerg Kaiser, Eggenstein (DE)

(72) Inventors: Erhard Schletterer, Dresden (DE); Tim Schaefer, Harztor (DE); Claus-Rupert Hohenthanner, Hanau (DE); Joerg Kaiser, Eggenstein (DE)

(73) Assignee: LI-TEC BATTERY GMBH, Kamenz (DE)

(21) Appl. No.: 13/817,367

(22) PCT Filed: Aug. 17, 2011
(86) PCT No.: PCT/EP11/04147

§ 371 Date: Apr. 24, 2013

(30) Foreign Application Priority Data
Aug. 19, 2010 (DE) 10 2010 034 825.2

(51) Int. Cl. H01M 2/10; A62C 3/06

(52) U.S. Cl. CPC H01M 2/1094; A62C 3/065
USPC 429/99; 429/100; 169/45; 427/58

(57) ABSTRACT

In an electrochemical energy store having a housing (I) and having at least one electrochemical cell (2) arranged in the housing (I), at least one wall of the housing (I) is coated or impinged on at least in regions with an extinguishing agent or an extinguishing agent additive (7-9).

The present invention relates to an electrochemical energy store. In the context of such energy stores, fire prevention and/or firefighting are of particular importance. Particularly when such energy stores are used in vehicles for transporting passengers, fire prevention or firefighting is an extremely important element in increasing the safety of such energy stores.

German patent DE 10 2008 059 948 A1 discloses a method and device for fire prevention and/or firefighting for a lithium-ion battery in a motor vehicle, particularly a motor vehicle in which the battery interior containing the individual battery cells is connected to an extinguishing agent reservoir via an emergency circuit, and in which the battery interior and the extinguishing agent reservoir are in fluid communication with one another at least temporarily via an emergency aperture.

The document DE 10 2008 059 942 A1 discloses a method and device for fire prevention and/or firefighting in a vehicle having a coolant circuit and a fire extinguishing device. The fire extinguishing device is furnished with emergency apertures that are opened for the purpose of firefighting and/or fire prevention and through which an extinguishing agent may be discharged.

The document DE 10 2008 059 968 A1 discloses a method and device for operating a lithium-ion battery of a vehicle, in which the battery interior containing the individual battery cells is in fluid communication with a coolant circuit of the battery via a line for the purpose of fire prevention and/or firefighting, and when necessary the coolant is introduced at least temporarily into the interior from the coolant circuit.

The object underlying the present invention is to publish a technical teaching with regard to fire prevention and/or firefighting in the context of electrochemical energy stores, and in so doing overcome certain limitations or drawbacks of known solutions to the extent possible.

This object is solved with an electrochemical energy store and a production method therefor or a method for firefighting or fire prevention in the context of electrochemical energy stores according to one of the independent claims. The subordinate claims are intended to obtain protection for advantageous refinements of the invention.

According to the invention, an electrochemical energy store is provided with a housing and at least one electrochemical cell arranged in the housing, in which at least one wall of the housing is coated or impinged on at least in regions with an extinguishing agent or an extinguishing agent additive.

In this context, the term electrochemical energy store is understood to mean a device that stores energy in chemical form and is capable of delivering this energy to an external consumer in electrical form. Important examples of such energy stores are fuel cells and galvanic cells as well as units comprising a plurality of such cells. The cells are preferably secondary cells, that is to say electrochemical energy stores that are not only capable of delivering energy stored in chemical form as electrical energy to a consumer, but which can also be charged, that is to say store energy in chemical form when it is received as electrical energy.

A housing for an electrochemical energy store is understood to be any device that is able and intended to prevent or inhibit the transport of substances between the components of the electrochemical energy store and its surroundings. The housing is preferably able and intended to prevent or inhibit an undesirable exchange of energy between the electrochemical energy store and its surroundings, particularly if such exchange were to involve the undesirable exchange in particular of non-electrical energy, for example thermal energy or mechanical energy. A housing thus serves preferably to protect the electrochemical energy store from undesirable effects by its surroundings, and at the same time to protect the surroundings from pollution or hazards that might emanate from the electrochemical energy store. Such housings are often, but not always, completely closed, and in some cases are configured to allow a controlled exchange of gases between the energy store and its surroundings.

The walls of a housing for such an energy store are the parts of the housing that are able to prevent or inhibit an undesirable exchange of substances or an undesirable exchange of energy between the energy store and its surroundings. In particular, the walls also include those components of the housing that separate the various sections of the housing from each other.

In this context, the term fire is understood to refer to any process in which the energy store or parts of the energy store or its surroundings is/are converted or decomposed in an undesirable chemical reaction. In this sense, fires are in particular exothermal chemical reactions between parts or components of an energy store and its surroundings, which often occur as a result of overheating of the energy store or its components.

In this context, an extinguishing agent is understood to be a substance or mixture of substances that exerts an extinguishing effect, in other words a suppressing effect on fires, and/or prevents or inhibits the origination of fires. In the context of the present invention, an extinguishing effect is understood to mean preferably an effect that counteracts a fire, that is to say it is able to prevent or alleviate the consequences or occurrence of a fire. Important examples of extinguishing agents or their preferred constituents are substances that remove a chemical reaction partner from a fire source, without which the fire is unable to sustain itself, or which inhibit a chemical reaction that favours the initiation or continued existence of a fire. Extinguishing agents are preferably produced by mixing an extinguishing agent additive with a solvent or a carrier substance.

In the context of the present invention, preferred extinguishing agent additives are substances known as gel forming agents, which combine with other materials, solvents or carrier substances, such as water in particular, to form adhesive and preferably viscous gels or viscoelastic fluids whose distinguishing features include a high degree of adhesion to burning objects and their surfaces. Gel forming agents are preferred examples of extinguishing agent additives that are preferably based on superabsorbers, and which are preferably stored in the form of powders or solid materials, or also as emulsions. Superabsorbers are often capable of absorbing many times their own weight or volume in water or another carrier substance. Water-based gels, which are formed by mixing the corresponding superabsorbers with water, are more effective than conventional foam blankets in that the airtight barrier layer that is formed lasts longer than with conventional foam blankets and releases much less water onto the burning material.

In the context of the description of the present invention, a viscoelastic fluid is understood to be a fluid that has the property of viscoelasticity. An (ideal) fluid is understood to be a substance that offers (almost) no resistance to shear that is retarded to any required degree. A distinction is made between compressible fluids (gases) and incompressible fluids (liquids). The general term “fluid” for both types is used because most physical laws apply (practically) equally to both gases and liquids, and many of their properties differ from each other only quantitatively, but not fundamentally qualitatively. Real fluids can be divided according to their behaviour into “Newtonian fluids” with the fluid mechanics by which they are described, and “non-Newtonian fluids” with the rheology by which they are described. Here, the difference consists in the flow behaviour of the medium, which is described by the functional relationship between shear stress and deformation rate or shear rate.

Viscoelasticity is the term used to describe the elasticity of fluids as a function of time, temperature and/or frequency, such fluids being for example polymer melts or solids, such as plastics. Viscoelasticity is characterized by a partly elastic, partly viscous behaviour. The material does not fully return to its original state after an externally acting force has been removed; the remaining energy is dissipated in the form of flow processes.

In the context of the description of the present invention, the term gel is understood to mean a finely dispersed system including at least a first, often solid, and at least a second, often fluid phase. A gel frequently has the form of a colloid. In such case, the solid phase forms a sponge-like, three-dimensional network whose pores are filled with a liquid, or also with a gas. Under these circumstances, the two phases often perfuse one another completely. Colloids are understood to be particles or droplets that are finely distributed throughout another medium (solid, gas or liquid), the dispersion medium.

According to a preferred embodiment of the invention, an electrochemical energy store is provided having a plurality of electrochemical cells, between which an extinguishing agent or extinguishing agent additive is disposed at least in regions. This electrochemical energy store preferably has frameless, prismatic electrochemical cells that are connected electrically via their lateral faces or contacts.

According to another preferred embodiment of the invention, an electrochemical energy store is provided in which at least one electrochemical cell is coated or impinged upon with an extinguishing agent or an extinguishing agent additive at least in regions. In this case, electrochemical energy stores are preferred in which the extinguishing agent or extinguishing agent additive are laminated on the lateral faces of the electrochemical cells at least in regions.

According to a further preferred embodiment of the invention, an electrochemical energy store is provided in which the extinguishing agent or extinguishing agent additive is a solid or an elastically deformable material or is contained in such a material. In this context, the term solid also encompasses compacted agglomerations of powders or foams, particularly elastically deformable foams.

According to a further preferred embodiment of the invention, an electrochemical energy store is provided in which the extinguishing agent or extinguishing agent additive is arranged as an intermediate element, in the form of spacers or edge protection plates for example, between adjacent pairs of electrochemical cells or between an electrochemical cell and a housing wall.

According to a further preferred embodiment of the invention, an electrochemical energy store is provided in which the extinguishing agent or extinguishing agent additive contains several times its own volume in water. In this context, extinguishing agents based on gel forming agents are particularly preferred, especially such that contain extinguishing agent additives based on the substances known as superabsorbers.

According to a further preferred embodiment of the invention, an electrochemical energy store is provided in which the extinguishing agent or extinguishing agent additive contains at least one polymer, preferably a copolymer, particularly preferably an acrylamide copolymer or a sodium acrylate copolymer.

According to a further preferred embodiment of the invention, an electrochemical energy store is provided in which the extinguishing agent or extinguishing agent additive contains at least one fatty acid ester.

According to a further preferred embodiment of the invention, an electrochemical energy store is provided in which the extinguishing agent or extinguishing agent additive contains at least one surfactant.

According to a further preferred embodiment of the invention, an electrochemical energy store is provided in which the extinguishing agent contains at least a mixture or emulsion of water and at least one fatty acid ester, at least one polymer, preferably a copolymer, particularly preferably an acrylamide copolymer or a sodium acrylate copolymer.

According to a further preferred embodiment of the invention, an electrochemical energy store is provided in which the extinguishing agent contains a mixture or emulsion of approximately 28% of at least one polymer, approximately 6% of at least one surfactant, approximately 23% of at least one ester oil, and approximately 43% water.

According to a further preferred embodiment of the invention, an electrochemical energy store is provided in which extinguishing agent additive is used in conjunction with water and contains a mixture or emulsion made up of approximately 50% of at least one polymer, approximately 10% of at least one surfactant, and approximately 40% of at least one ester oil.

According to a further preferred embodiment, the carrier substance, with which the extinguishing agent additive may be mixed to form an extinguishing agent, is a coolant, which flows in a closed coolant circuit during normal operation of the energy store, which circuit is designed in such manner that in the event of a fire the coolant may be discharged from the closed coolant circuit at certain points and fulfil its extinguishing effect at those points. In this way, the extinguishing effect may be performed in targeted manner at certain points that are affected by a fire; at the same time, the function of the substance as a coolant may be preserved.

For the purposes of the present invention, the term coolant is understood to refer to a flowable material, particularly a gas-phase or liquid heat transport medium that is capable of absorbing heat from its surroundings, transporting this heat by its flow and also releasing the heat to its surroundings, and whose physical properties render it suitable for transporting heat by thermal conduction and/or thermal transport via aerodynamic or hydrodynamic currents, also particularly via convection currents in the heat transport medium. Important examples of thermal transport media that are commonly used in the art are air or water or other standard cooling agents. Other gases or liquids, such as chemically inert (weakly reactive) gases or liquids, for example inert gases or liquefied inert gases or substances with high thermal capacity and/or thermal conductivity are usable depending on the application context.

In this context, a flowable material may be understood to mean any material in which an aerodynamic or hydrodynamic current may be created, or in which such a flow may be maintained. Examples of such materials are particularly gases and liquids. However, currents in this sense may also be maintained or generated in a mixture of liquids or gases with finely distributed solids, also referred to as aerosols, or in colloidal solutions.

A particularly preferred apparatus according to the invention comprises a device for stabilizing the coolant pressure when the coolant is discharged from the coolant circuit at certain points thereof in the event of a fire. This embodiment of the invention may be associated with maintaining the coolant pressure at or close to its original level and thus also with the cooling effect when the coolant is discharged a certain points of the coolant circuit to fulfil its extinguishing function.

Also preferred is an embodiment of the invention in which water is used as the coolant, and in which this coolant flows through a closed coolant circuit when the energy store is operating normally, which circuit being designed in such manner that the water is able to escape from the closed coolant circuit at certain points in the event of a fire, and while being discharged from the coolant circuit is mixed with an extinguishing agent additive, wherein a gel or viscoelastic fluid is formed.

In this context, it is particularly preferred to use an extinguishing agent additive consisting of a mixture of at least one polymer, at least one surfactant and at least one ester oil.

In addition, an additive consisting of a mixture of approximately 50% of at least one polymers, approximately 10% of at least one surfactant and approximately 40% of at least one ester oil is particularly preferred.

When measuring the proportions of the mixture, it should preferably be borne in mind that the advantageous effects of the coolant/extinguisher mixture or of the additive are based on the viscoelasticity of the coolant/extinguisher mixture and on the mixture's ability to bind water. This enables the adhesive force of the coolant to be increased even on smooth surfaces. The liquid does not run off ineffectively.

Particularly with mixtures of polymers, ester oils, surfactants and water, if the mixture ratios are calculated under the influence of kinetic energy, the resulting viscosity is considerably less than if the substances are at rest. In this way, such a mixture is able to flow through a coolant circuit with low viscosity and at the same time have a high viscosity upon being discharged from this coolant circuit at the site of a fire. The flowability of such mixtures thus depends in large part on the flow velocity.

The chemicophysical bonding of the liquid in a gel structure enables the evaporation rate of the liquid to be reduced significantly, even at relative high temperatures. In this way, it is possible to reduce the quantity of liquid consumed considerably. The liquid that is bound up in a gel structure is able to fulfil its cooling function more effectively at the site of the fire due to the relatively large layer thickness and the reduced evaporation rate. This effect is particularly significant for fighting extremely hot fires.

In several preferred embodiments, the extinguishing agent additive is preferably in the form of a mixture consisting of P percent by weight of at least on polymer, T percent by weight of at least one surfactant and E percent by weight of at least one ester oil relative to the total quantity of the additive, wherein

45≦P≦55,

8≦T≦12,

35≦E≦45

and

P+T+E=100

In the following, the invention will be described in greater detail with reference to preferred embodiments and with the aid of the drawing. In the drawing:

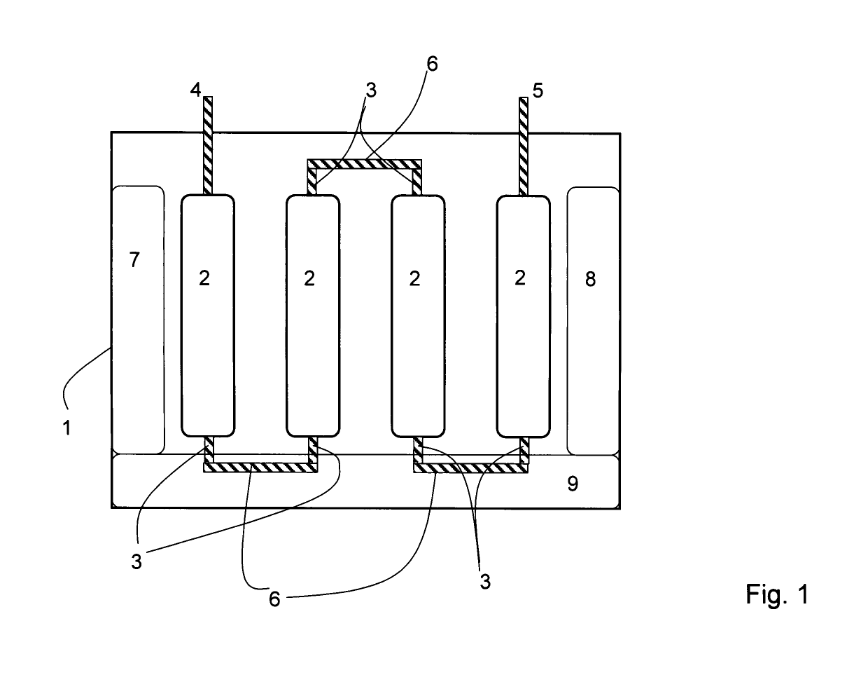

FIG. 1 shows a first embodiment of the present invention;

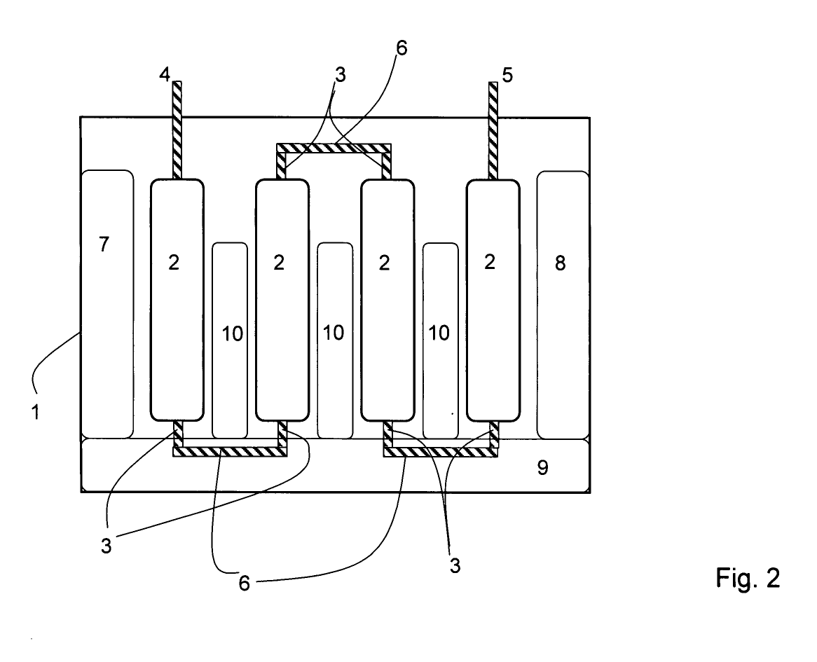

FIG. 2 shows a second embodiment of the present invention;

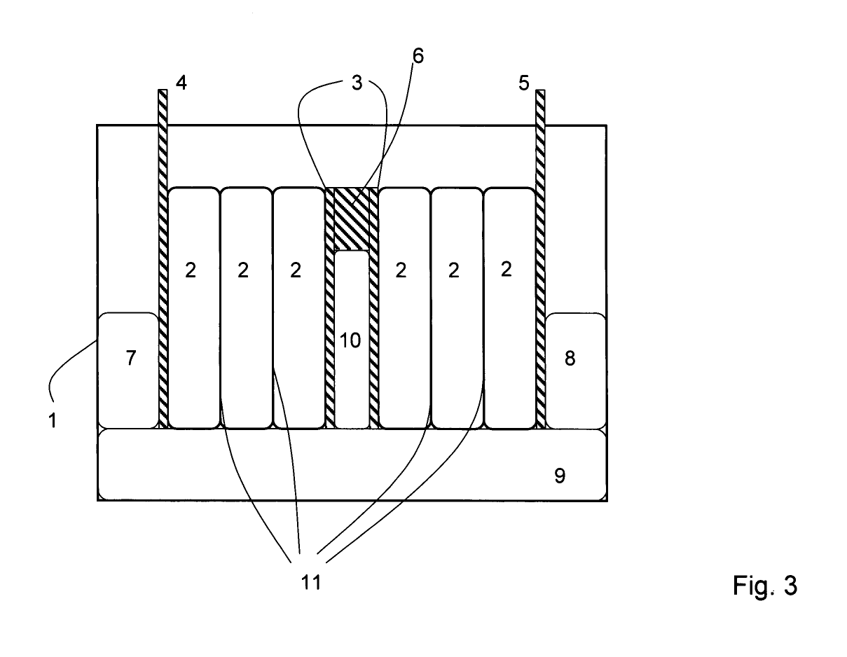

FIG. 3 shows a third embodiment of the present invention;

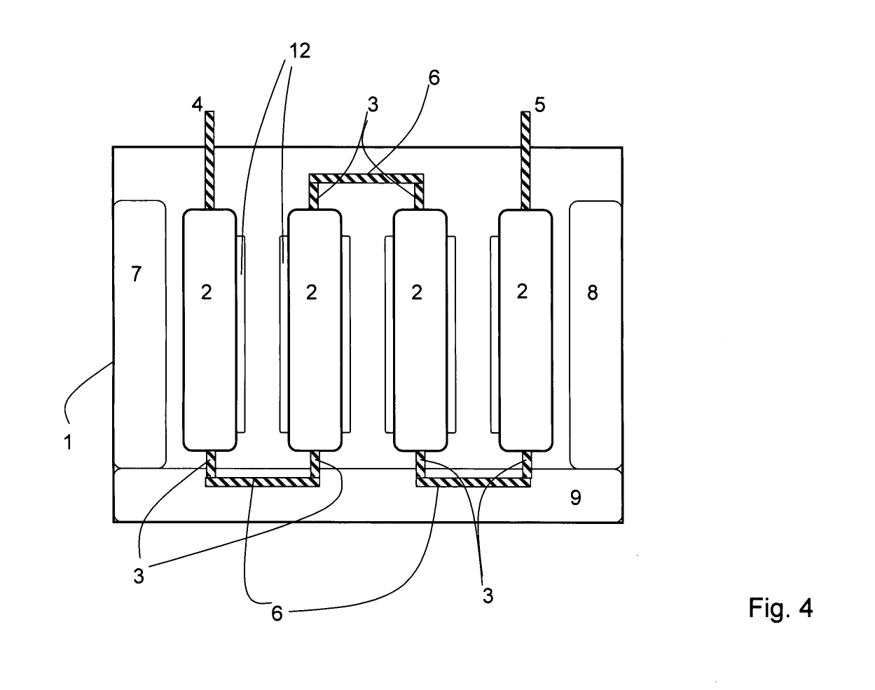

FIG. 4 shows a fourth embodiment of the present invention;

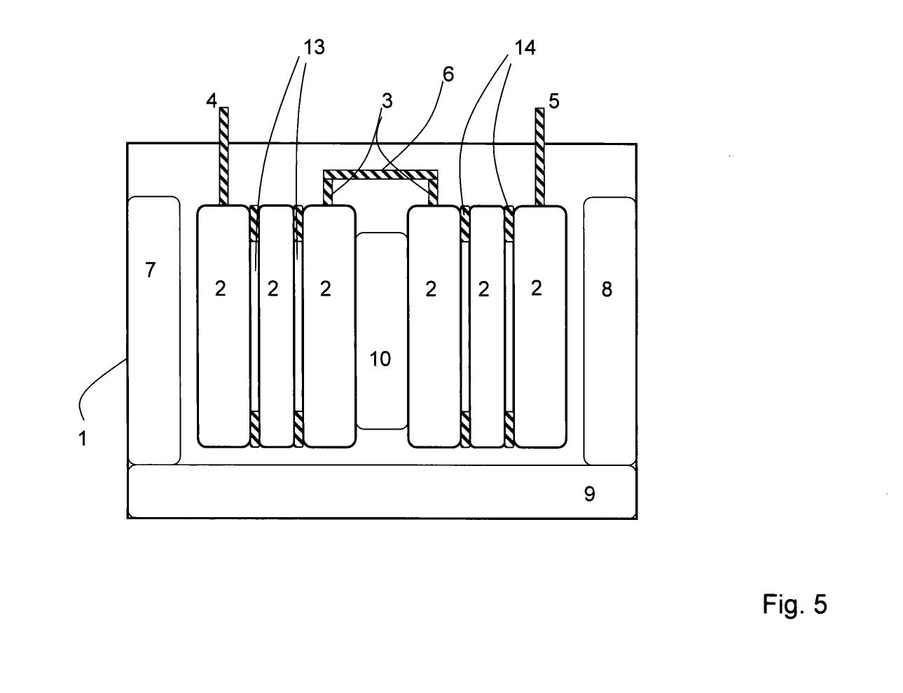

FIG. 5 shows a fifth embodiment of the present invention;

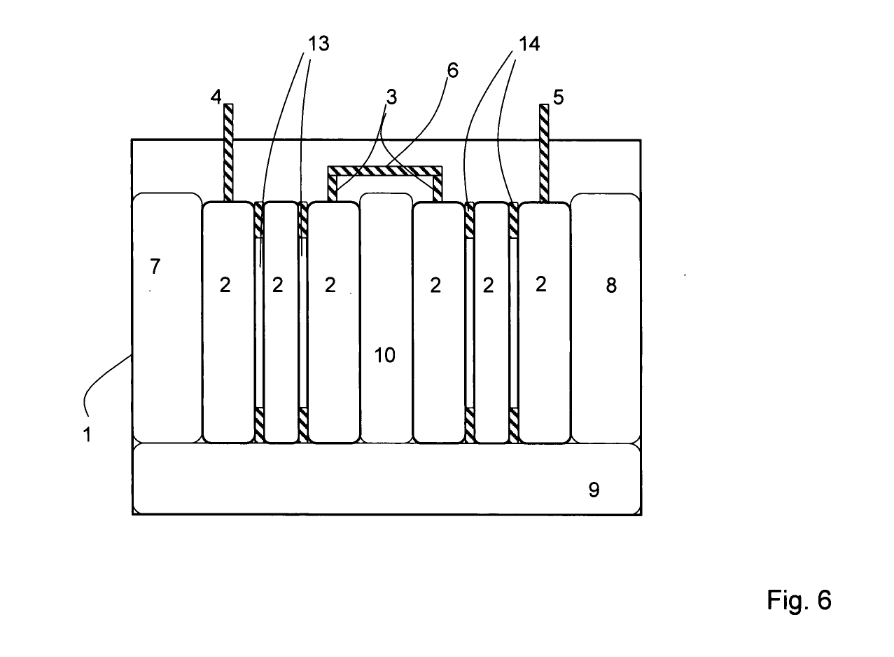

FIG. 6 shows a sixth embodiment of the present invention;

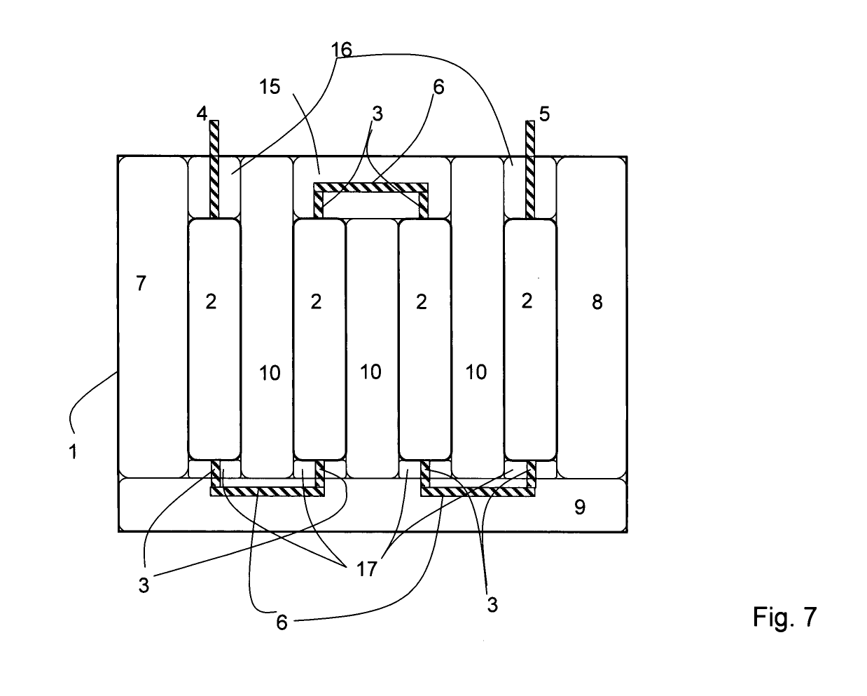

FIG. 7 shows a seventh embodiment of the present invention;

The embodiment of an electrochemical energy store according to the invention represented diagrammatically in FIG. 1 comprises a housing 1, the interior walls of which are coated or impinged on with an extinguishing agent or an extinguishing agent additive 7. 8, and the bottom of which is coated or impinged on with an extinguishing agent or an extinguishing agent additive 9. In this embodiment, the electrochemical energy store comprises a plurality of electrochemical cells 2, in this case four, of which the contacts, that is to say the electrical connectors 3 are interconnected by means of electrical connecting elements 6 to form an electrical series connection, so that the sum of the voltages generated by the electrochemical cells 2 depicted in FIG. 1 is incident at contacts 4 and 5 leading from the housing.

This embodiment represents an improvement with regard to known designs of electrochemical energy stores in that, if a fire occurs inside the housing, in the course of which burning or combustible materials fall onto the baseplate of housing 1 under the effect of gravity, the extinguishing agents or extinguishing agent additives 7, 8 and 9 applied to the walls and baseplate of the housing will have a fire-retardant effect on the burning or combustible materials, thus effectively counteracting the fire or its development. If coatings 7, 8 and 9 are not extinguishing agents but an extinguishing agent additive instead, it is advantageous if the substance that combines with the extinguishing agent additive to yield the extinguishing agent is released during or as a result of the destruction of the burning electrochemical cells 2 so that it is able to be mixed with or react with the extinguishing agent additive to yield the extinguishing agent. In other cases, a carrier substance such as water, with which the extinguishing agent additive may be mixed or combined to form an extinguishing agent, may be introduced from the outside in order to fight or prevent a fire.

Preferred embodiments of the invention also include those in which the materials used to coat or impinge on the housing walls are composite materials that also consist in part of an extinguishing agent additive and a carrier substance that combines with the extinguishing agent additive to yield the extinguishing agent in such manner that this composite material is thoroughly mixed or reacts chemically under the effect of the elevated temperature caused by the fire, thereby yielding the extinguishing agent. Other preferred embodiments provide that the extinguishing agent additive is applied to the interior wall of the housing, or even to the exterior wall of the housing by coating or by other means in such manner that when a solvent or other carrier substance, such as water, is directed against the housing walls from the outside, the extinguishing agent additive that has been applied to the housing walls or the housing bottom combines with the solvent introduced from the outside and thus reacts with it to form the extinguishing agent.

A preferred extinguishing agent additive is a mixture or emulsion consisting of at least one polymer, at least one surfactant and at least one ester oil. Such mixtures or emulsions may be mixed with water to form an extinguishing agent that holds the water against the burning surfaces for a sustained period, thereby achieving a more prolonged, more effective fire retardant and cooling effect than water without the extinguishing agent additive. In this context, the extinguishing agent additive preferably contains approximately 50% of at least one polymer, preferably approximately 10% of at least one surfactant, and preferably approximately 40% of at least one ester oil.

In cases in which the extinguishing agent additive has already been combined with its solvent or carrier substance, particularly with water as a mixture or emulsion, when it is applied to the housing walls or the housing bases or other elements of the electrochemical energy store, the extinguishing agent preferably has a gel-like, particularly a viscous consistency and preferably contains approximately 28% of at least one polymer, preferably approximately 6% of at least one surfactant, approximately 23% of at least one ester oil and approximately 43% water.

In conjunction with all the embodiments or variants of the invention illustrated or described, whose features may also be used advantageously in combination, an extinguishing agent or extinguishing agent additive is preferred that has the form of a gel or a viscous fluid. Other embodiments of the invention provide for an extinguishing agent or extinguishing agent additive that is a solid or an elastically deformable material, or that is contained in such a solid or elastically deformable material.

In the embodiment of the invention shown schematically in FIG. 2, extinguishing agents or extinguishing agent additives 10 are arranged between electrochemical cells 2 in addition to the extinguishing agents or extinguishing agent additives 7, 8 applied to the housing walls and the extinguishing agents or extinguishing agent additives 9 applied to the housing bottom, wherein this arrangement of extinguishing agents or extinguishing agent additives is preferably made to regions thereof, as is shown diagrammatically in FIG. 2.

FIG. 3 shows an embodiment of the invention in which electrochemical cells 2 have no electrical contacts 3 that lead out of the cell housing or the cell package, but in which the electrochemical cells 2 are contacted via their cell walls or the lateral surfaces 11 of the cell package, so that it is possible to connect multiple cells 2 in series by ensuring that the electrically conductive or at least partially electrically conductive cell walls are in contact with each other, as is shown in FIG. 3.

Electrical contacts 4 and 5, which are in contact with the cell walls of the outer electrochemical cells, pass out of housing 1 at the end of a cell stack consisting of a plurality of cells 2. In this embodiment, extinguishing agents or extinguishing agent additives are applied to regions of the cell walls 7, 8, or applied to regions of baseplate 9. The cell stack shown in FIG. 3 includes two cell stacks, each of which contains three cells, and which are connected via electrical connectors 3 and 6. Electrical connector element 6 is configured such that an extinguishing agent or extinguishing agent additive 10 may be arranged in regions between the two partial cell stacks.

FIG. 4 illustrates schematically an embodiment of the invention in which electrochemical cells, or the side walls thereof, are coated at least in regions with an extinguishing agent or extinguishing agent additive 12. In this way, when the cell package breaks open a fire that is caused by the escape of burning or combustible material may be suppressed by the extinguishing agent or extinguishing agent additive that has been applied to the cell package walls.

FIG. 5 shows an embodiment of the invention in which electrochemical cells 2 are laminated onto each other at least in regions by their lateral faces and the extinguishing agent 13 or an extinguishing agent additive 13. In the regions of the cell walls in which no extinguishing agent or extinguishing agent additive 13 is provided, contact elements or contact layers of an electrically conductive material 14 are preferably provided, and these assure the interconnection of the cells with each other. In places where no electrical contact 14 is provided between electrochemical cells and where preferably an extinguishing agent or extinguishing agent additive 10 is arranged between such electrochemical cells, connectors 3 for the cells that protrude out of the housing or the cell package may be connected to each other via an electrically conductive connecting element 6 in the same way as in other embodiments of the invention.

FIG. 6 shows a variant of the embodiment shown in FIG. 5, in which wall coatings 7 and 8 and bottom coating 9 are extended by the extinguishing agent or extinguishing agent additive such that these coatings reach as far as the edges and walls of the electrochemical cells. The extinguishing agent or extinguishing agent additive 10 arranged between the partial cell stacks is also prolonged in such manner that the gap between the electrochemical cells and the gap below the electrochemical cells are almost completely filled. With this embodiment of the invention, the fire-retardant and cooling effect of the extinguishing agent is brought to bear directly on the housing or package walls of electrochemical cells 2.

FIG. 7 illustrates a further variant of the embodiments of the invention shown in FIGS. 5 and 6, in which the spaces above and below the cell housing edges, where the connectors preferably pass out of the cell housings or packages, are filled with extinguishing agent or extinguishing agent additives 15, 16 and 17.

In the context of the description of the present invention, the following reference numerals were used in the figures:
1 Housing
2 Electrochemical cell
3 Electrical connection (connectors) of an electrochemical cell
4, 5 Connectors protruding from the housing
6 Electrically conductive connection between connectors
7, 8 Extinguishing agent or extinguishing agent additive arranged on the interior side of a wall of the housing
9 Extinguishing agent or extinguishing agent additive arranged on the bottom of the housing
10 Extinguishing agent or an extinguishing agent additive arranged between electrochemical cells
11 Touching cell walls
12 Coating of a cell wall with an extinguishing agent or extinguishing agent additive
13 Extinguishing agent or extinguishing agent additive arranged or laminated between electrochemical cells
14 Electrically conductive connection between cell walls
15, 16, 17 Extinguishing agent or extinguishing agent additive arranged on the cell edges

1-17. (canceled)

18. An electrochemical energy store, comprising:
a housing; and
at least one electrochemical cell disposed inside the housing,
wherein at least an area of at least one wall of the housing is coated with or exposed to an extinguishing agent or extinguishing agent additive, and wherein the extinguishing agent or extinguishing agent additive is a gel or a viscous or viscoelastic fluid.

19. The electrochemical energy store according to claim 18, wherein the at least one electrochemical cell comprises a plurality of electrochemical cells, between which an extinguishing agent or an extinguishing agent additive is arranged at least in regions.

20. The electrochemical energy store according to claim 19, wherein the plurality of electrochemical cells are frameless, prismatic electrochemical cells that are connected electrically via their lateral faces or contacts.

21. The electrochemical energy store according to claim 18, wherein at least the at least one electrochemical cell is at least partially coated or impinged upon with an extinguishing agent or an extinguishing agent additive.

22. The electrochemical energy store according to claim 21, wherein the extinguishing agent or extinguishing agent additive is laminated on lateral faces of the at least one electrochemical cell at least in regions.

23. The electrochemical energy store according to claim 18, wherein the extinguishing agent or extinguishing agent additive is a solid or an elastically deformable material or is contained in a solid or an elastically deformable material.

24. The electrochemical energy store according to claim 18, wherein the extinguishing agent or extinguishing agent additive is arranged as an intermediate element between adjacent pairs of electrochemical cells or between an electrochemical cell and a housing wall.

25. The electrochemical energy store according to claim 18, wherein the extinguishing agent or extinguishing agent additive contains multiple times its own volume in water or is configured to absorb multiple times its own weight in water.

26. The electrochemical energy store according to claim 18, wherein the extinguishing agent or extinguishing agent additive comprises at least one polymer.

27. The electrochemical energy store according to claim 26, wherein the at least one polymer is an acrylamide copolymer or a sodium acrylate copolymer.

28. The electrochemical energy store according to claim 18, wherein the extinguishing agent or extinguishing agent additive comprises at least one fatty acid ester.

29. The electrochemical energy store according to claim 18, wherein the extinguishing agent or extinguishing agent additive comprises at least one surfactant.

30. The electrochemical energy store according to claim 18, wherein the extinguishing agent or extinguishing agent additive contains at least a mixture or emulsion of water and at least one fatty acid ester, and at least one polymer.

31. The electrochemical energy store according to claim 30, wherein the at least one polymer is an acrylamide copolymer or a sodium acrylate copolymer.

32. The electrochemical energy store according to claim 18, wherein the at least an area of the at least one wall of the housing is coated with or exposed to the extinguishing agent, and wherein the extinguishing agent contains a mixture or emulsion consisting of:
approximately 28% of at least one polymer;
approximately 6% of at least one surfactant;
approximately 23% of at least one ester oil; and
approximately 43% water.

33. The electrochemical energy store according to claim 18, wherein the at least an area of the at least one wall of the housing is coated with or exposed to the extinguishing agent additive, and wherein the extinguishing agent additive is used in conjunction with water and contains a mixture or emulsion consisting of:
approximately 50% of at least one polymer;
approximately 10% of at least one surfactant; and
approximately 40% of at least one ester oil.

34. A method for producing an electrochemical energy store, the method comprising:
coating at least an area of at least one wall of a housing of the electrochemical energy store with an extinguishing agent or extinguishing agent additive, or exposing the at least an area of the at least one wall of the housing of the electrochemical energy store with or to the extinguishing agent or extinguishing agent additive,
wherein the extinguishing agent or extinguishing agent additive is a gel or a viscous or viscoelastic fluid.

35. A method comprising:
fighting or preventing a fire by using an extinguishing agent or extinguishing agent additive coated or exposed to at least an area of at least one wall of a housing of an electrochemical energy store,
wherein the extinguishing agent or extinguishing agent additive is a gel or a viscous or viscoelastic fluid.
